(19) United States
(12) Patent Application Publication
(10) Pub. No.: US 2014/0222879 A1
(43) Pub. Date: Aug. 7, 2014

(54) METHOD AND SYSTEM FOR UNMOUNTING AN INACCESSIBLE NETWORK FILE SYSTEM

(71) Applicant: APPLE INC., Cupertino, CA (US)

(72) Inventors: William L. RICKER, Cupertino, CA (US); Guy HARRIS, Palo Alto, CA (US); George K. COLLEY, Cupertino, CA (US)

(73) Assignee: APPLE INC., Cupertino, CA (US)

(21) Appl. No.: 13/757,630

(22) Filed: Feb. 1, 2013

(51) Int. Cl. G06F 17/30

(52) U.S. Cl. CPC G06F 17/30194
USPC 707/827

(57) ABSTRACT

The invention provides a technique for managing hard-mounted network file systems (NFSs). First, a network file system (NFS) interface detects that a hard-mounted NFS is inaccessible. In response, the NFS interface obtains a list of virtual nodes (vNodes) associated with the hard-mounted NFS. If the NFS interface determines that each vNode in the list of vNodes is only associated with a read IN/OUT (I/O) operation, then the NFS interface automatically unmounts the hard-mounted NFS since doing so does not compromise the coherency of the hard-mounted NFS. Alternatively, if the NFS interface determines that at least one vNode in the list of vNodes is associated with data that is open for a write I/O operation, is mapped into a memory, or is associated with at least one dirty page, then the NFS interface does not unmount the hard-mounted NFS since doing so will compromise the coherency of the hard-mounted NFS.

### TECHNICAL FIELD

The present invention relates generally to computing devices. More particularly, present embodiments of the invention relate to a method and system for unmounting an inaccessible network file system.

### BACKGROUND

The landscape of computer file system technologies has evolved based on, at least in part, the type of hardware components that become commonly included in popular computing devices. For example, network file system (NFS) technology growth and popularity has spurred as a result of network hardware being included in virtually all modern computing devices (e.g., smart phones and desktop/laptop computers). As commonly understood, an NFS server enables network-connected computing devices to access files stored on remote storage devices that are managed by the NFS server. The computing devices do not have direct access to the storage devices managed by the NFS server, but instead are configured to interface with an NFS manager that executes on the NFS server and is configured to carry out file read/write requests issued by the computing devices.

According to popular NFS configurations, network administrators can configure an NFS server to require computing devices to either “soft-mount” or “hard-mount” network file systems that are managed by the NFS server. Notably, when a computing device soft-mounts a network file system—and a connection disruption occurs between the computing device and the NFS server—the computing device will attempt to re-connect to the NFS server until either a reconnection attempt threshold or a timeout period is exceeded. In the event that the attempt threshold or the timeout period is exceeded, the computing device automatically unmounts the soft-mounted network file system. Although the soft-mount approach provides the benefit of flexibility for users with computing devices that intermittently connect to an NFS server, the soft-mount approach can also compromise coherency of the network file system. For example, an application executing on the computing device may issue a large file write operation that is only partially completed when the computing device disconnects from an NFS server (e.g., when an employee suspends his or her computing device when leaving work). Continuing with this example, when the computing device attempts to re-connect to the NFS server (e.g., when the employee arrives home)—and when no connection to the NFS server can be re-established (e.g., since the employee cannot access the NFS server via his or her private home network)—the application that initially issued the large file write operation experiences an I/O error, and the large file write operation is never carried out.

One attempt to mitigate the coherency issues related to soft-mounting network file systems involves hard-mounting the network file systems instead. In particular, hard-mounted network file systems are configured to remain intact (i.e., they are not automatically unmounted) even when the connection to the NFS server is disrupted for prolonged periods of time. Thus, when applying the above example to a hard-mounted network file system, the application would not receive an I/O error and the large file write operation would remain pending until the connection between the computing device and the NFS server is ultimately re-established. Once the connection is re-established, the large file write operation is carried out, thereby maintaining coherency of the network file system. Accordingly, hard-mounted network file systems are desirable for a variety of network file system environments where lost or incomplete I/O operations are unacceptable (e.g., a repository for a software project that manages code contributions from software engineers).

Although hard-mounted network file systems can cure some of the deficiencies of soft-mounted network file systems, they nonetheless have their own unique set of problematic behavior under certain scenarios. In particular, a computing device may continue to attempt accessing an NFS server that manages a hard-mounted network file system even when the hard-mounted network file system is not needed (e.g., when an employee takes his or her computer home from work for the weekend). Notably, such continual access attempts can cause the computing device to hang or even become inoperable, and can also put unnecessary strain on the network that is being used to attempt accessing the NFS server (e.g., the employee's home network). To alleviate this issue, the user of the computing device must restart the computing device to eliminate the hard-mounted network file system altogether, which is cumbersome and inefficient.

### SUMMARY

This paper describes various embodiments that relate to a technique for forcibly unmounting hard-mounted network file systems. First, an NFS interface detects that a hard-mounted network file system has become inaccessible. In response, the NFS interface obtains a list of virtual nodes (vNodes) associated with the hard-mounted network file system. If the NFS interface determines that each vNode in the list of vNodes is only associated with a read IN/OUT (I/O) operation, then the NFS interface automatically unmounts the hard-mounted NFS since doing so does not compromise the coherency of the hard-mounted NFS. Alternatively, if the NFS interface determines that at least one vNode in the list of vNodes is associated with data that is open for a write I/O operation, is mapped into a memory, or is associated with at least one dirty page, then the NFS interface does not unmount the hard-mounted NFS since doing so will compromise the coherency of the hard-mounted NFS.

One embodiment of the present invention sets forth a computer-implemented method for automatically unmounting a hard-mounted network file system. The method includes the steps of detecting that the hard-mounted network file system is inaccessible, and, in response to the detecting, automatically unmounting the hard-mounted network file system if it is determined that the hard-mounted network file system can be unmounted without compromising coherency of the hard-mounted network file system.

Other embodiments include a system that is configured to carry out the method steps described above, as well as a non-transitory computer readable medium storing instructions that, when executed by a processor, cause the processor to carry out the method steps described above.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing portable computing devices. These drawings in no way limit any changes in form and detail that may be made to the invention by one skilled in the art without departing from the spirit and scope of the invention. The embodiments will be readily understood by the following detailed description in conjunction with the accompanying drawings, wherein like reference numerals designate like structural elements, and in which:

FIG. 1 illustrates a client/server system configured to implement the various embodiments of the invention described herein;

FIG. 2 illustrates a detailed view of the system of FIG. 1, according to one embodiment of the invention;

FIG. 3 illustrates a method for automatically unmounting a hard-mounted network file system in response to a disruption in the connection to the hard-mounted network file system, according to one embodiment of the invention;

FIG. 4 illustrates a method for automatically unmounting a hard-mounted network file system without compromising the coherency of the hard-mounted network file system, according to one embodiment of the invention; and

FIG. 5 illustrates an example configuration of the client/server devices of FIG. 1, according to one embodiment of the invention.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

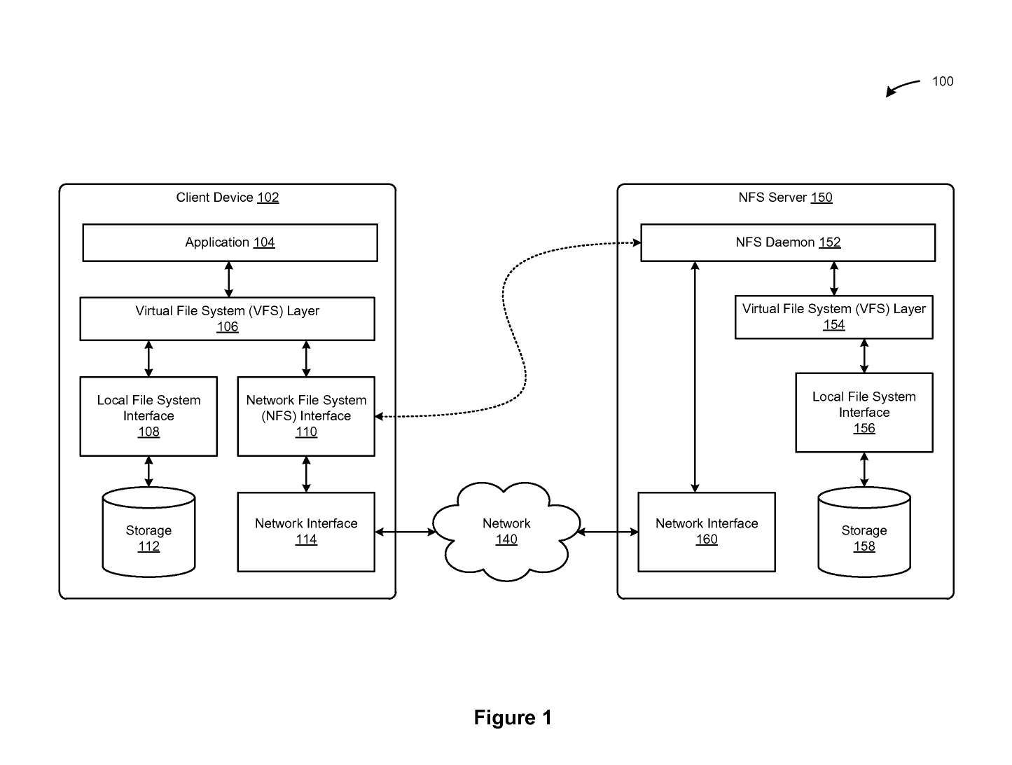

FIG. 1 illustrates a system 100 configured to implement the various embodiments of the invention described herein. As shown in FIG. 1, the system 100 includes a client device 102 and a network file system (NFS) server 150 that are configured to communicate via network 140. The client device 102 includes hardware components typically included in a computing device, such as a processor and temporary memory (not illustrated), a storage 112 (e.g., a hard drive or a solid state drive) and a network interface 114 (e.g., a wireless network card or a network interface card (NIC)). Although not illustrated in FIG. 1, the client device 102 is configured to execute an operating system so that software applications, such as application 104, can execute on the client device 102 and provide useful functionality to an end-user of the client device 102.

As shown in FIG. 1, the client device 102 includes a virtual file system (VFS) layer 106 that manages access to both a local file system interface 108 as well as an NFS interface 110. In particular, the local file system interface 108 enables the application 104 to access the storage 112 included in client device 102, which is typically used to store personal data of the end-user (e.g., digital media). The NFS interface 110 also enables the application 104 to access storage that is managed by the NFS server 150 via the network interface 114. According to various embodiments described herein, the NFS interface 110 “hard-mounts” a network file system that is managed by the NFS server 150 and made accessible to the client device 102.

As commonly understood, when a computer system, e.g., the client device 102, hard-mounts a network file system, the network file system continues to remain mounted regardless of whether the network file system is accessible to the client device 102. In essence, an I/O operation issued to a hard-mounted network file system will continue to be issued to that hard-mounted network file system until the I/O operation is carried out within the hard-mounted network file system. In this manner, data coherency—which represents a guarantee that an I/O operation made at the client device 102 is ultimately reflected within the hard-mounted network file system (or vice-versa)—is effectively maintained between the client device 102 and the hard-mounted network file system.

In contrast, a network file system that is soft-mounted on the client device 102 represents a network file system that is automatically unmounted by the client device 102 when the network file system becomes unreachable to the client device 102, e.g., when the client device 102 loses network connectivity. According to popular soft-mount configurations, the client device 102 is configured to unmount the soft-mounted network file system when a threshold timeout period lapses or when a threshold number of I/O operations have issued to the soft-mounted network file system and no response is received. As a result, data coherency is not maintained between the client device 102 and a soft-mounted network file system, which is undesirable in many use-case scenarios.

The hierarchy of the hard-mounted network file system is managed by the VFS layer 106 and is presented to the application 104 as if the hard-mounted network file system were locally stored within the client device 102. In particular, the VFS layer 106 manages, for directories/files of the hard-mounted network file system, “virtual nodes” (vNodes) that are pointers (referred to herein as “handles”) to the directories/files and are used by the VFS layer 106 and the NFS interface 110 to access the directories/files. Typically, the network file system managed by the NFS server 150 is accessible to the client device 102 only when the client device 102 meets certain network-connectivity requirements. For example, the network 140 may represent a private company network that can only be accessed by the client device 102 when the client device 102 is physically connected to the private company network (e.g., at a user station) or within range of a wireless node that is part of the private company network.

As is well-known, the VFS layer 106 is configured to receive an I/O request from applications (e.g., the application 104) and to automatically route the I/O request to the appropriate handler: the local file system interface 108, or the NFS interface 110. In instances where the NFS interface 110 is the appropriate handler, the NFS interface 110 receives a processed I/O request from the VFS layer 106 and translates the I/O request into one or more network packets. The one or more network packets are then transmitted via network interface 114 to the NFS server 150 for processing, as described in greater detail below. After the NFS server 150 processes the transmitted network packets, the NFS server 150 routes to the client device 102 network packets that include data related to the initial I/O request received at the VFS layer 106, e.g., acknowledgement data that indicates a write I/O request was successfully carried out at the NFS server 150, file data read out of memory in response to a file read request, and the like. These network packets are then translated by the NFS interface 110 back into I/O format so that the VFS layer 106 can provide interpretable information to the application that originally issued the I/O request.

As described above, the NFS server 150 is configured to receive and process network packets generated and transmitted by the client device 102 via the network 140. Like the client device 102, the NFS server 150 includes hardware components typically included in a computing device, such as a processor and temporary memory (not illustrated), storage 158 (e.g., an array of storage devices) and a network interface 160. In most cases, the storage 158 represents an array of disks that are managed by the local file system interface 156 using well-known technologies, such as RAID (redundant array of inexpensive disks) technology. The NFS server 150 also includes an NFS daemon 152, a VFS layer 154, and a local file system interface 156. As illustrated in FIG. 1, the network interface 160 is configured to interface with the network 140 so that the network interface 160 can receive network packets that are transmitted by the client device 102. In turn, the NFS daemon 152, in conjunction with the VFS layer 154, translates the network packets into I/O requests that are carried out by the local file system interface 156. After the I/O requests are carried out by the local file system interface 156, the VFS layer 154, in conjunction with the NFS daemon 152, generates relevant network packets that are transmitted back to the client device 102 and are handled by the NFS interface 110 and the VFS layer 106 included in the client device 102 according to the techniques described above.

As previously described herein, embodiments of the invention are directed to enabling the client device 102 to automatically unmount a hard-mounted network file system that is managed by the NFS server 150 when the NFS server 150 is inaccessible, so long as certain specific conditions are met.

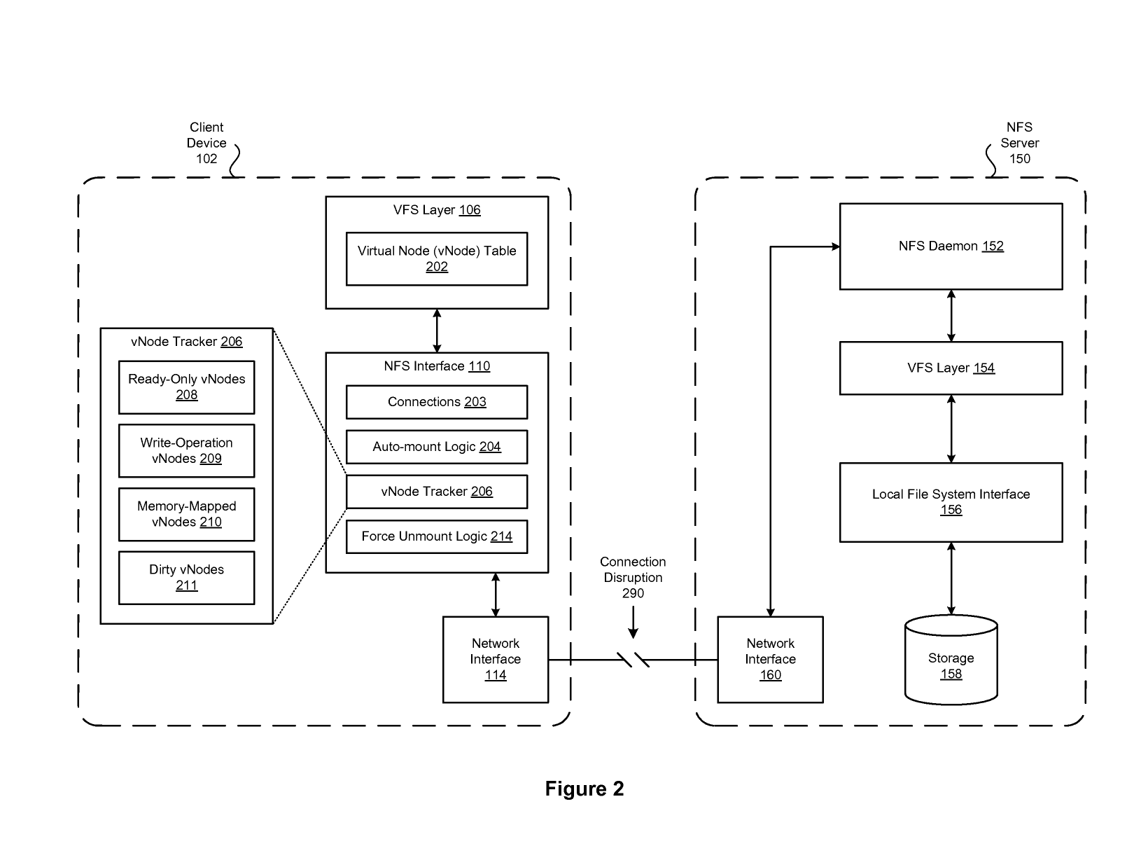

FIG. 2 illustrates a more detailed view of the system 100 of FIG. 1, according to one embodiment of the invention. As shown in FIG. 2, the VFS layer 106 includes a vNode table 202 for managing vNodes associated with directories/files of a network file system that is managed by the NFS server 150 and accessed by the client device 102. As also shown in FIG. 2, the NFS interface 110 includes connections 203, auto-mount logic 204, vNode tracker 206 and force unmount logic 214. The connections 203 component included in the NFS interface 110 enables the NFS interface 110 to track connections to the NFS server 150. As described in greater detail herein, the auto-mount logic 204 is configured to detect when the NFS server 150 is accessible via the network 140 and, in response, automatically hard-mount any network file systems managed by the NFS server 150 that include directories/files to which entries within the vNode table 202 correspond. In contrast, the force unmount logic 214 is configured to detect when the NFS server 150 is not accessible via the network 140 (represented by connection disruption 290), and, if additional conditions described herein are met, forcibly unmount any network file systems that are managed by the NFS server 150. In particular, the NFS interface 110 is configured to reference vNode tracker 206 in order to determine whether a forcible unmount of the network file system can be executed without compromising coherency of the network file system.

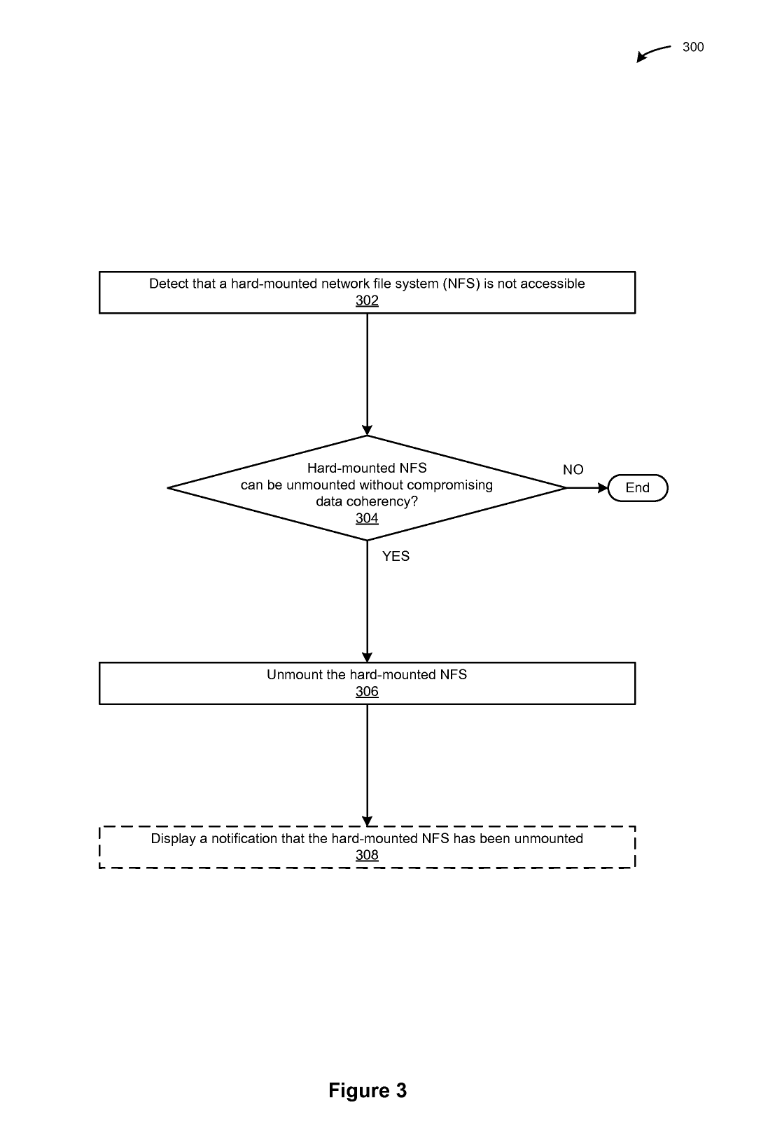

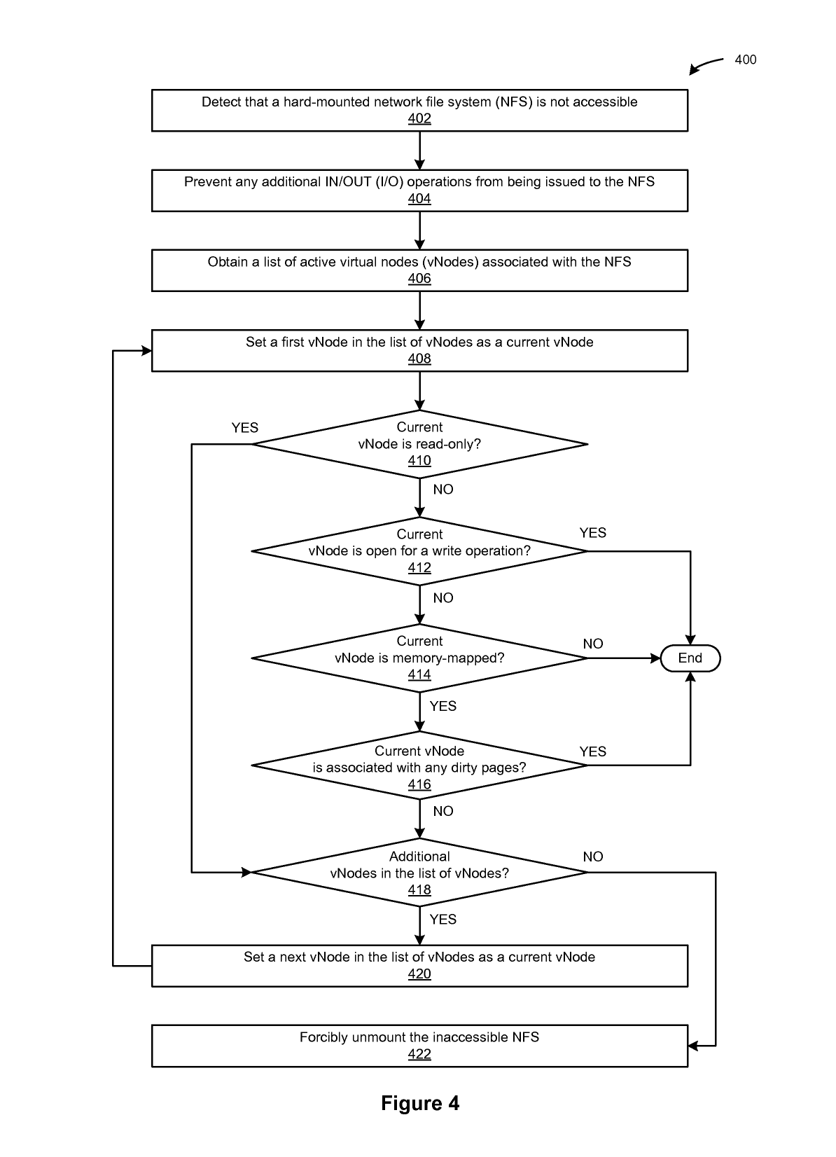

As shown in FIG. 2, the vNode tracker 206 is configured to maintain records for vNodes that are read-only (vNodes 208), for vNodes that are currently open for write-operations (write-operation vNodes 209), for vNodes that are memory-mapped (memory-mapped vNodes 210), and for vNodes that are associated with dirty pages in memory (dirty vNodes 211). In one embodiment, each of the vNodes 208, 209, 210 and 211 is associated with a different counter that is atomically updated when vNodes are added or removed from the respective collection of vNodes. In this manner, the vNode tracker 206 can efficiently determine, if any, the vNodes that need to be processed according to the techniques described below in conjunction with FIGS. 3 and 4. One example of a read-only vNode 208 is a digital image that is being viewed but not edited on the client device 102. One example of a write-operation vNode 209 is an edited video file that is in the process of being saved from the client device 102 onto the NFS server 150. One example of a memory-mapped vNode 210 is an executable file that is loaded onto the client device 102 from the NFS server 150 for execution. Finally, one example of a dirty vNode 211 is a text file whose updates have been stored locally on the client device 102 but have not yet been transmitted to the NFS server 150 for persistent storage. As noted above—and as described in greater detail herein—the NFS interface 110 is able to effectively determine, by tracking these various types of vNodes, when a forcible unmount of a network file system can be carried out without compromising the coherency of the network file system.

FIG. 3 illustrates a method for automatically unmounting a hard-mounted network file system in response to a disruption in the connection to the hard-mounted network file system, according to one embodiment of the invention. As shown, the method 300 begins at step 302, where the NFS interface 110 detects that a hard-mounted network file system (NFS) is not accessible, e.g., a hard-mounted NFS hosted by the NFS server 150.

At step 304, the NFS interface 110 determines whether the hard-mounted NFS can be unmounted without compromising data coherency thereof, the details of which are described below in conjunction with FIG. 4. If, at step 304, NFS interface 110 determines that hard-mounted NFS can be unmounted without compromising data coherency, then the method 300 proceeds to step 306. Otherwise, the method 300 ends, since the hard-mounted NFS should not be forcibly unmounted when doing so may compromise data coherency of the hard-mounted NFS. At step 306, NFS interface 110 unmounts the hard-mounted NFS. At step 308, NFS interface 110 optionally displays a notification that the hard-mounted NFS has been unmounted.

FIG. 4 illustrates a method 400 for automatically unmounting a hard-mounted network file system without compromising the coherency of the hard-mounted network file system, according to one embodiment of the invention. Although the method steps 400 are described in conjunction with the systems of FIGS. 1-2, persons skilled in the art will understand that any system configured to perform the method steps, in any order, is within the scope of the invention.

As shown, the method 400 begins at step 402, where the NFS interface 110 detects that a hard-mounted network file system is not accessible. The hard-mounted network file system may become inaccessible when, for example, a network connection is lost to the NFS server that manages the hard-mounted network file system (e.g., NFS server 150). The hard-mounted network file system may also become inaccessible when, for example, the NFS server that manages the hard-mounted network file system (e.g., NFS server 150) experiences an internal error and can no longer service the NFS requests that are being issued by the NFS server 150.

At step 404, the NFS interface 110 prevents any additional I/O operations from being issued to the hard-mounted network file system. This step is executed so that the NFS interface 110 can analyze all active vNodes associated with the file system and definitively determine whether the hard-mounted network file system can be unmounted without compromising the coherency of the file system.

At step 406, the NFS interface 110 obtains a list of active vNodes associated with the hard-mounted network file system. In one embodiment, the NFS interface 110 references vNode table 202 and vNode tracker 206 to obtain or build the list of active vNodes, where active vNodes represent any vNodes that are associated with the hard-mounted network file system and have been interacted with since the hard-mounted network file system was initially mounted.

At step 408, the NFS interface 110 sets a first vNode in the list of vNodes as a current vNode. At step 410, the NFS interface 110 determines whether current vNode is read-only. Notably, read-only vNodes are benign to the coherency of the hard-mounted network file system since they merely represent data that has been read out of the hard-mounted network file system. If, at step 410, the NFS interface 110 determines that current vNode is a read-only vNode, then the method 400 proceeds to step 418, where additional vNodes, if any, are analyzed by the NFS interface 110 according to the steps 410-416 described herein.

At step 412, the NFS interface 110 determines whether current vNode is open for a write operation. Notably, if just a single vNode in the list of active vNodes is, in fact, open for a write operation, then the method 400 terminates since a forcible unmount of the hard-mounted network file system would prevent the write operation from successfully completing, thereby compromising the coherency of the hard-mounted network file system. Accordingly, if, at step 412, the NFS interface 110 determines that current vNode is open for a write operation, then the method 400 ends and the hard-mounted network file system remains mounted. Otherwise, the method 400 proceeds to step 414.

At step 414, the NFS interface 110 determines whether current vNode is memory-mapped. As previously noted herein, memory-mapped vNodes represent vNodes that actively exist in temporary memory (e.g., random access memory of the client device 102) and therefore are in use by the client device 102. Therefore, the NFS interface 110 should not forcibly unmount the hard-mounted network file system when a vNode is memory-mapped. Accordingly, if, at step 414, the NFS interface 110 determines that current vNode is memory-mapped, then the method 400 ends and the hard-mounted network file system remains mounted. Otherwise, the method 400 proceeds to step 416.

At step 416, the NFS interface 110 determines whether current vNode is associated with any dirty pages. As previously noted herein, a vNode associated with dirty pages represents, for example, a data file where updates to the file have been stored locally within the client device 102 but have not yet been persisted to the storage included in the NFS server 150. For this reason, the NFS interface 110 should not forcibly unmount the hard-mounted network file system when there exists a vNode that is associated with dirty pages. Accordingly, if, at step 416, the NFS interface 110 determines that current vNode is associated with any dirty pages, then the method 400 ends and the hard-mounted network file system remains mounted. Otherwise, the method 400 proceeds to step 418.

At step 418, the NFS interface 110 determines whether additional vNodes are included in the list of vNodes. If, at step 418, the NFS interface 110 determines that additional vNodes are included in the list of vNodes, then the method 400 proceeds to step 420. At step 420, the NFS interface 110 sets a next vNode in the list of vNodes as a current vNode, and the method 400 proceeds back to step 410, whereupon the steps 410-420 are carried out for each additional vNode that is included in the list of vNodes.

Referring back now to step 418, if the NFS interface 110 determines that additional vNodes are not included in the list of vNodes, then the method 400 proceeds to step 422, where the NFS interface 110 forcibly unmounts the inaccessible hard-mounted network file system.

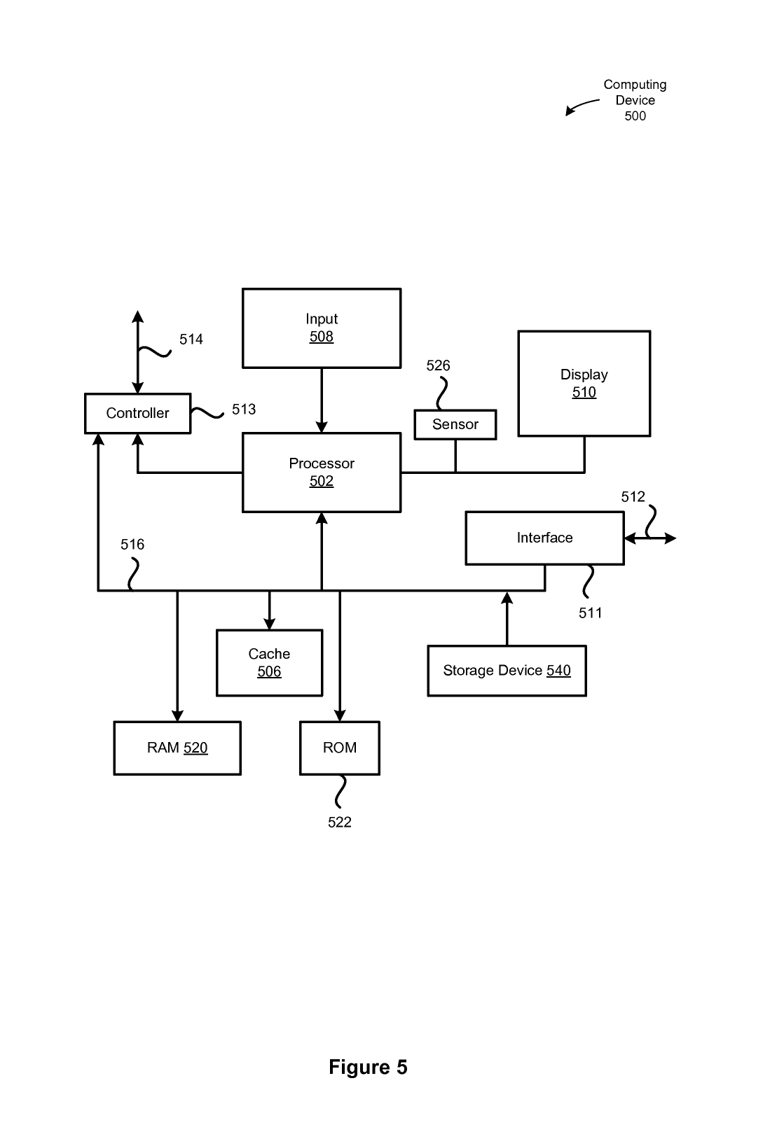

FIG. 5 illustrates an example configuration of the client device 102/NFS server 150 of FIG. 1, according to one embodiment of the invention. In particular, the computing device 500 represents the example configuration, and includes a processor 502 that pertains to a microprocessor or controller for controlling the overall operation of computing device 500. Computing device 500 can also include a user input device 508 that allows a user of the computing device 500 to interact with the computing device 500. For example, user input device 508 can take a variety of forms, such as a button, keypad, dial, touch screen, audio input interface, visual/image capture input interface, input in the form of sensor data, etc. Still further, computing device 500 can include a display 510 (screen display) that can be controlled by processor 502 to display information to the user. Data bus 516 can facilitate data transfer between at least storage device 540, cache 506, processor 502, and controller 513. Controller 513 can be used to interface with and control different equipment through equipment control bus 514.

Computing device 500 can also include a network/bus interface 511 that couples to data link 512. Data link 512 can allow computing device 500 to couple to a host computer or to accessory devices. The data link 512 can be provided over a wired connection or a wireless connection. In the case of a wireless connection, network/bus interface 511 can include a wireless transceiver. Sensor 526 can take the form of circuitry for detecting any number of stimuli. For example, sensor 526 can include any number of sensors for monitoring a manufacturing operation such as for example a Hall Effect sensor responsive to external magnetic field, an audio sensor, a light sensor such as a photometer, computer vision sensor to detect clarity, a temperature sensor to monitor a molding process and so on.

In some embodiments, storage device 540 can be flash memory, semiconductor (solid state) memory or the like. Storage device 540 can typically provide high capacity storage capability for the computing device 500. However, since the access time to the storage device 540 can be relatively slow (especially if storage device 540 includes a mechanical disk drive), the computing device 500 can also include cache 506. The cache 506 can include, for example, Random-Access Memory (RAM) provided by semiconductor memory. The relative access time to the cache 506 can be substantially shorter than for storage device 540. However, cache 506 may not have the large storage capacity of storage device 540. The computing device 500 can also include RAM 520 and Read-Only Memory (ROM) 522. The ROM 522 can store programs, utilities or processes to be executed in a non-volatile manner. The RAM 520 can provide volatile data storage, such as for cache 506, and stores instructions related to entities configured to carry out embodiments of the present invention, such as the NFS interface 110 of FIG. 1.

In sum, embodiments of the invention provide a technique for managing hard-mounted network file systems. First, an NFS interface detects that a hard-mounted network file system has become inaccessible. In response, the NFS interface obtains a list of vNodes associated with the hard-mounted network file system. If the NFS interface determines that each vNode in the list of vNodes is only associated with a read IN/OUT (I/O) operation, then the NFS interface automatically unmounts the hard-mounted NFS since doing so does not compromise the coherency of the hard-mounted NFS. Alternatively, if the NFS interface determines that at least one vNode in the list of vNodes is associated with data that is open for a write I/O operation, is mapped into a memory, or is associated with at least one dirty page, then the NFS interface does not unmount the hard-mounted NFS since doing so will compromise the coherency of the hard-mounted NFS.

Notably, embodiments of the invention are not limited solely to hard-mounted network file systems, and can be applied to popular approaches/devices used to hard-mount file systems within a computing device. Consider, for example, a removable storage device (e.g., an external hard drive or universal serial bus (USB) stick) whose file system is mounted by a computing device. Oftentimes, such a removable storage device is physically detached from the computing device without giving prior notice to the computing device. Under this scenario, and according to conventional techniques, the mounted file system of the removable storage device remains intact and causes the computing device to hang since the computing device continually attempts to access the detached removable storage device. However, by applying the various embodiments of the invention described herein, the computing device can analyze the nature in which members of the file system are being accessed—i.e., whether they are only being read, are being written to, are memory mapped, or are associated with dirty pages—and effectively determine if the file system can be forcibly unmounted without compromising the coherency thereof.

One advantage provided by the embodiments of the invention is the elimination of system “hanging” that typically occurs when a hard-mounted file system becomes inaccessible to a client device and nonetheless remains mounted as with conventional techniques. Another advantage is that, even when the hard-mounted file system is forcibly unmounted, the coherency of the hard-mounted file system is maintained. Yet another advantage is that the hard-mounted file system is automatically unmounted without requiring input or analysis from a user of the client device, thereby providing a seamless operating environment in which the user can interface with the hard-mounted file system without needing to manage the complexities involved in maintaining coherency of the hard-mounted file system.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

We claim:

1. A computer-implemented method for automatically unmounting a hard-mounted network file system, the method comprising:
detecting that the hard-mounted network file system is inaccessible; and
in response to the detecting, automatically unmounting the hard-mounted network file system if it is determined that the hard-mounted network file system can be unmounted without compromising coherency of the hard-mounted network file system, wherein the determination includes:
processing a list of virtual nodes (vNodes) that are associated with the hard-mounted network file system to identify the nature in which each virtual node in the list of virtual nodes is being accessed.

2. The method of claim 1, wherein the hard-mounted network file system is inaccessible when a network connection to a computing device that manages the hard-mounted network file system is disrupted.

3. The method of claim 1, further comprising:
upon the detecting, preventing any subsequent IN/OUT (I/O) operations from being issued to the hard-mounted network file system.

4. The method of claim 3, wherein determining that the hard-mounted network file system can be unmounted without comprising coherency of the hard-mounted network file system comprises:
obtaining the list of vNodes; and
determining that each vNode in the list of vNodes is only associated with a read I/O operation.

5. The method of claim 3, wherein determining that the hard-mounted network file system cannot be unmounted without comprising coherency of the hard-mounted network file system comprises:
obtaining the list of vNodes; and
determining that at least one vNode in the list of vNodes is associated with data that is:
open for a write I/O operation;
mapped into a memory; or
associated with at least one dirty page.

6. The method of claim 3, further comprising:
determining that the unmounted hard-mounted network file system is accessible; and
remounting the unmounted hard-mounted network file system.

7. The method of claim 1, further comprising:
displaying a notification that the hard-mounted network file system has been forcibly unmounted.

8. A non-transitory computer readable storage medium storing instructions that, when executed by a processor, cause the processor to implement a method for automatically unmounting a hard-mounted network file system, the method comprising:
detecting that the hard-mounted network file system is inaccessible; and
in response to the detecting, automatically unmounting the hard-mounted network file system if it is determined that the hard-mounted network file system can be unmounted without compromising coherency of the hard-mounted network file system.

9. The non-transitory computer readable storage medium of claim 8, wherein the hard-mounted network file system is inaccessible when a network connection to a computing device that manages the hard-mounted network file system is disrupted.

10. The non-transitory computer readable storage medium of claim 8, further comprising:
upon the detecting, preventing any subsequent IN/OUT (I/O) operations from being issued to the hard-mounted network file system.

11. The non-transitory computer readable storage medium of claim 10, wherein determining that the hard-mounted network file system can be unmounted without comprising coherency of the hard-mounted network file system comprises:
obtaining a list of virtual nodes (vNodes) that are associated with the hard-mounted network file system; and
determining each vNode in the list of vNodes is only associated with a read I/O operation.

12. The non-transitory computer readable storage medium of claim 10, wherein determining that the hard-mounted network file system cannot be unmounted without comprising coherency of the hard-mounted network file system comprises:
obtaining a list of virtual nodes (vNodes) that are associated with the hard-mounted network file system; and
determining that at least one vNode in the list of vNodes is associated with data that is:
open for a write I/O operation;
mapped into a memory; or
associated with at least one dirty page.

13. The non-transitory computer readable storage medium of claim 10, further comprising:
determining that the unmounted hard-mounted network file system is accessible; and
remounting the unmounted hard-mounted network file system.

14. The non-transitory computer readable storage medium of claim 8, further comprising:
displaying a notification that the hard-mounted network file system has been forcibly unmounted.

15. A system, comprising:
a network file server; and
a client computing device configured to implement a method for automatically unmounting a hard-mounted network file system that is hosted by the network file server, the method comprising:
detecting that the hard-mounted network file system is inaccessible; and
in response to the detecting, automatically unmounting the hard-mounted network file system if it is determined that the hard-mounted network file system can be unmounted without compromising coherency of the hard-mounted network file system.

16. The system of claim 15, wherein the hard-mounted network file system is inaccessible when a network connection between the network file system and the client computing device is disrupted.

17. The system of claim 15, further comprising:
upon the detecting, preventing any subsequent IN/OUT (I/O) operations from being issued to the hard-mounted network file system.

18. The system of claim 17, wherein determining that the hard-mounted network file system can be unmounted without comprising coherency of the hard-mounted network file system comprises:
obtaining a list of virtual nodes (vNodes) that are associated with the hard-mounted network file system; and
determining each vNode in the list of vNodes is only associated with a read I/O operation.

19. The system of claim 17, wherein determining that the hard-mounted network file system cannot be unmounted without comprising coherency of the hard-mounted network file system comprises:
obtaining a list of virtual nodes (vNodes) that are associated with the hard-mounted network file system; and
determining that at least one vNode in the list of vNodes is associated with data that is:
open for a write I/O operation;
mapped into a memory; or
associated with at least one dirty page.

20. The system of claim 17, further comprising:
determining that the unmounted hard-mounted network file system is accessible; and
remounting the unmounted hard-mounted network file system.
